(19) United States
(12) Patent Application Publication
(10) Pub. No.: US 2023/0184320 A1
(43) Pub. Date: Jun. 15, 2023

(54) Connection Arrangement

(71) Applicant: ZF Friedrichshafen AG, Friedrichshafen (DE)

(72) Inventors: Thomas Kramer, Oldenburg (DE); Konstantin Brunner, Damme (DE)

(21) Appl. No.: 18/081,530

(22) Filed: Dec. 14, 2022

(30) Foreign Application Priority Data
Dec. 15, 2021 (DE) 10 2021 214 401.2

(51) Int. Cl. F16H 57/04; F16K 11/076; F16L 29/00

(52) U.S. Cl. CPC F16H 57/0408; F16K 11/076; F16L 29/007; F01M 11/0458

(57) ABSTRACT

A connection arrangement for filling and draining a liquid includes a sealing element arrangement and a joining arrangement. The sealing element is movable between a closed position and an open position. A filling passage of the connection arrangement is defined by at least one of the sealing element arrangement or the joining arrangement. A draining passage of the connection arrangement is definable by the sealing element arrangement and the joining arrangement, the draining passage being adjustable by moving the sealing element arrangement between the closed position and the open position.

### CROSS-REFERENCE TO RELATED APPLICATION

The present application is related and has right of priority to German Patent Application No. 10 2021 214 401.2 filed on Dec. 15, 2021, the entirety of which is incorporated by reference for all purposes.

### FIELD OF THE INVENTION

The present invention relates generally to a connection arrangement, in particular to a sealing element arrangement that includes a filler tube and a joining arrangement, in particular for filling and draining a receiving chamber of a motor vehicle with operating fluid.

### BACKGROUND

Receiving chambers for operating fluids of motor vehicles are often accessible only from the vehicle floor (vehicle underside) for structural reasons and due to limited installation space. Such receiving chambers, for example, an oil pan, are therefore usually drained and filled to a predefined level from underneath during final assembly or servicing, and therefore appropriate connections are provided.

Typically, this is also the case for vehicle transmissions, which must be filled with the operating fluid via an oil pan from the vehicle floor. Such oil pans have two separate connections that include two separate oil pan connections on the underside of the oil pan. The first connection is an oil drain connection, through which used oil is drainable. The second connection is used for filling the receiving chamber or such an oil pan, where the second connection includes a filler tube that protrudes into the interior space at the inside of the oil pan. In order to set a predefined oil level, the oil is introduced into the receiving chamber via the filler tube using a pump/temperature control unit until the liquid level defined along the length of the filler tube has been reached.

All oil pans and the connections of the oil pans are checked for leak tightness before installation to avoid expensive reworking after the oil pans have been installed and filled. For the leakage test, each connection of the oil pan is closed in order to subsequently check the leak tightness using a testing device. Every connection that must be checked creates testing effort and represents a potential risk of leakage. For quantities of up to multiple millions of components per year, each additional component also represents a considerable cost factor.

Each additional connection at the oil pan can represent a potential leak point during operation. In case of failure, this can result in expensive service costs for the vehicle operator, since the replacement of a sealing element at the oil pan connection is often associated with the complete draining of the operating fluid. In addition, every leakage is also an environmental problem.

### SUMMARY OF THE INVENTION

The present invention provides a connection arrangement for filling and draining a liquid that at least partially eliminates the above-described disadvantages.

According to a first aspect, the present invention provides a connection arrangement for filling and draining a liquid. The connection arrangement includes a sealing element arrangement and a joining arrangement, and further the connection arrangement simultaneously includes a filling passage and a draining passage. The draining passage is adjustable by displacing the sealing element arrangement between a closed position and an open position.

### BRIEF DESCRIPTION OF THE DRAWINGS

Embodiments of the invention are now described by way of example and with reference to the attached figures, wherein:

FIG. 1 shows a perspective exploded view of a first embodiment of a connection arrangement according to the invention arranged in an oil pan, the connection arrangement including a joining arrangement;

FIG. 2 shows a perspective detailed view of the joining arrangement shown in FIG. 1;

FIG. 3 shows a bottom view of the connection arrangement of FIG. 1, particularly illustrating an actuating element;

FIG. 4 shows another view of the connection arrangement shown in FIG. 3, particularly illustrating an oil pan connection (sealing cap, screw cap);

FIG. 5a shows a perspective detailed view of the connection arrangement of FIG. 1 from the inside of the connection arrangement with a closed draining passage;

FIG. 5b shows a perspective detailed view of the connection arrangement shown in FIG. 5a with an open draining passage;

FIG. 6a shows a schematic sectional view of a second embodiment of a connection arrangement with an open draining passage; and

FIG. 6b shows a schematic sectional view of a third embodiment of a connection arrangement with an open draining passage.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The following general remarks regarding the embodiments are provided prior to a detailed description of FIG. 1.

The term “actuating element” describes a feature for being able to manipulate a degree of freedom in a defined manner, for example, for transmitting a torque of the sealing element arrangement. The actuating element allows manipulation to be carried out using a tool or manually.

The term “snap-action element” describes a functional element, in the case of which the snap-action element of the joining part elastically deforms and, thereafter, detachably or non-detachably (non-destructively or destructively removably) hooks together with the joining partner in a defined position in a form-locking manner. As a result, the joining part can be easily mounted and locked in its joining position by controlled hook engagement. Snap-in connections are, among other things, snap-in hooks, ball joint connections, or annular snap joints. The utilized material is plastic or spring steel due to the elastic material properties. Plastic snap-in elements are integrable into a one-piece component.

There are embodiments in which the connection arrangement includes a through-hole in the joining arrangement, the through-hole being arranged concentrically to the filling passage, wherein the connection arrangement is fillable with liquid through the through-hole via the filling passage in the closed position of the connection arrangement and, in the open position of the connection arrangement, the liquid is drainable through the through-hole via the draining passage (which opens into the through-hole or the filling passage, if necessary), wherein the sealing element arrangement includes a filler tube, which projects into the filling chamber, and the maximum fill level is limited by the length of a tube section at the filler tube. Depending on the type, the through-hole includes an internal thread or another force- or form-locking connecting structure. For filling, a hose that includes an appropriate adapter can be connected to the through-hole or the filling passage and the liquid can be pumped into the receiving chamber.

Depending on the embodiment, the filler tube is one piece with the oil pan, one piece with the sealing element arrangement, or a separate part. In addition, the filler tube has a constant or variable cross-section, depending on the embodiment.

There are embodiments in which the sealing element arrangement includes a first recess or “opening,” wherein the sealing element arrangement is displaceable through the through-hole, wherein the sealing element arrangement includes an actuating element in the filling passage. If a basic geometry of the sealing element arrangement is cylindrical or plate-like, the first recess is partially positioned in the lateral region or at the end face. The basic geometry and size of the first recess varies depending on the viscosity of the liquid to be used and a predefined draining speed. In one preferred embodiment, the first recess corresponds to the dimensions of a second recess or “opening” at a joining arrangement. The tolerances of the boundary surfaces between the sealing element arrangement and the joining arrangement are selected such that the sealing element arrangement is seated in a glidingly or slidingly displaceable manner on the joining arrangement and remains in the preset position of the sealing element arrangement despite external forces (vibrations, impacts) arising during operation. Depending on the embodiment, the actuating element is arranged concentrically in the filling passage or eccentrically at the sealing element arrangement and is a hexagon, TORX, ridge-like, or another bolt head system.

There are embodiments in which the joining arrangement includes a second recess, which, in the open position, is aligned with the first recess and forms the draining passage that includes the through-hole, wherein the second recess is closeable by the sealing element arrangement in the closed position. The second recess corresponds to the dimensions of the first recess in order to enable a uniform and controlled liquid flow. Advantageously, the lowest point of the second recess is arranged as close as possible to the lowest point of the oil pan or corresponds to the lowest point of the oil pan. As a result, the receiving chamber is drained as completely as possible during servicing.

There are embodiments in which the sealing element arrangement in a mounting position is mountable onto the joining arrangement via a dog clutch-like or bayonet-like geometry and lockable in a nondetachable functional position or functional position range by being turned. The sealing element arrangement in the functional position is mounted so as to be horizontally displaceable with respect to the joining arrangement and fixed against being lifted off by a holding structure.

The sealing element arrangement is joinable onto the joining arrangement mechanically or manually. The holding structure secures the sealing element arrangement against being vertically lifted off the joining arrangement. In another embodiment, the holding structure is a screw-like connection or as a bayonet joint. Another type of form-fitting connection is also usable. The functional position range includes the closed position and the open position of the draining passage.

There are embodiments in which the sealing element arrangement in the functional position is displaceable between a closed position and an open position. The rotary stops are arranged on the joining arrangement and the sealing element arrangement such that a defined angular position is set. The angular position defines the displacement between the closed position and the open position. A stepless adjustment between the closed position and the open position is possible. However, there are also embodiments that have multi-stage and, if necessary, detented adjustment possibilities, for example, to regulate the through-flow. In order to ensure the closed position of the draining passage during operation, an additional rotation prevention means is installable, so that the sealing element arrangement cannot turn due to external effects such as vibrations or impacts.

There are embodiments in which the functional position is settable via a limitation of the maximum turning displacement of the sealing element arrangement. The closed position is settable via an elastic snap-action element at the sealing element arrangement and a filling rotary stop on the joining arrangement. The closed position is reachable by turning the sealing element arrangement in a first direction of rotation. The open position is settable via a ridge-shaped sealing element rotary stop arranged on the sealing element arrangement and a draining rotary stop arranged on the joining arrangement. The open position is reachable by turning the sealing element arrangement in a second direction of rotation. The filling rotary stop and the draining rotary stop of the joining arrangement are one piece or “formed as one piece” with the oil pan. Similarly, the snap-action element and the sealing element rotary stop are one piece or “formed as one piece” with the sealing element arrangement. The elastic snap-action element is a horizontally aligned, ridge-type or tab-type element at the lateral region or at the plate edge region of the sealing element arrangement and has a vertical resilience. The injection molding process is an advantageous manufacturing process for the connection arrangement.

There are embodiments in which the joining arrangement is arranged as one piece on the inside, in particular at an oil pan, wherein the oil pan is a transmission component, wherein the liquid is a lubricating fluid or a cooling liquid, wherein the mounted oil pan is fillable and drainable on the outside through the through-hole, wherein the through-hole is closable in a liquid-tight manner from the outside in the operating state using an oil pan cap. The oil pan and the sealing element arrangement are each made of plastic in an injection molding process, preferably of a thermoplastic. Due to the high flexibility of plastic materials, a better leak tightness is set in or created when the oil pan is mounted at a metallic counterpart (transmission housing) than is the case with a metallic oil pan. Due to the plastic construction, further functional integrations, such as cooling fins or contaminant collection magnets, and other functions are integrable into the surface in a problem-free manner. Various plastics or fiber-reinforced plastics are usable, depending on the requirement profile. Preferred plastics include polyamide (PA) or polybutylene terephthalate (PBT), where PBT, for example, is distinguished by low distortion and a high dimensional accuracy in production. In order to improve the material properties, for example, against impact, a glass fiber reinforcement is addable in order to increase the breaking elongation and elastic energy absorption. An advantageous material matrix is PA or PBT with a volumetric content of glass fiber of 15% (PA GF15, PBT GF15). The oil pan cap is mountable using an internal thread in the through-hole. The oil pan cap includes an actuating element, which corresponds to the actuating element of the sealing element arrangement. The seal against an outflow of liquid is implementable via a gasket that is mountable at the oil pan or the oil pan cap.

There are embodiments in which the sealing element arrangement is horizontally displaceable through the through-hole using the actuating element from the outside of the oil pan and is displaceable into a closed position or an open position from the outside. The arrangement is configurable such that the sealing element arrangement is turned using a tool, such as a hex key or a wrench, or manually. During servicing, initially the oil pan cap is removed and, thereafter, the draining passage is opened in a controlled manner. In this way, an uncontrolled, premature oil discharge is avoided.

There are oil pan arrangements in which the oil pan is fillable and drainable via the identical connection in the bottom area of the oil pan. A potential leak point is preventable by using only one connection. Using injection molding, the tool costs are reduced. In addition, an oil pan cap and a gasket are not necessary, which further saves costs.

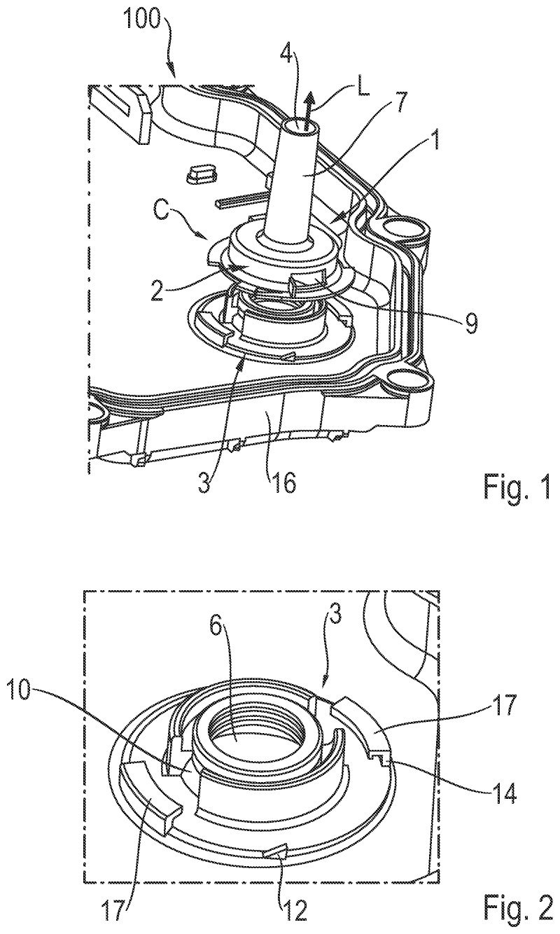

According to the present invention, FIG. 1 shows an oil pan arrangement 100 that includes an integrated connection arrangement 1 for filling and draining a liquid L. The connection arrangement 1 is subdivided into a circular joining arrangement 3 (which is shown in more detail in FIG. 2), and a separate, plate-shaped sealing element arrangement 2, with the circular joining arrangement 3 being connected to an oil pan 16 as one piece. The circular joining arrangement 3 is subdivided into an inner circular portion and an outer circular portion. FIG. 1 shows a mounting position C in which the cylindrical sealing element arrangement 2 is arranged over the joining arrangement 3 without contact, wherein a lower end face of the sealing element arrangement 2 is arranged in parallel to the joining arrangement 3. The plate-shaped sealing element arrangement 2 includes a recess at the side facing the oil pan 16, resulting in a shell-like hollow body. The sealing element arrangement 2 includes a cylindrical filler tube 7, which is connected as one piece to the end face of the sealing element arrangement 2 facing away from the oil pan. A filling passage 4 is therefore formed in the sealing element arrangement 2 and extends through the sealing element arrangement 2, concentrically to the sealing element arrangement 2. The filling passage 4 is arranged concentrically to a through-hole 6 in the joining arrangement 3. The sealing element arrangement 2 includes a first recess 9 in the lateral region, the first recess 9 forms a connection to the filling passage 4. The inner circular portion of the joining arrangement 3 is cylindrical and extends from the outside of the oil pan 16 at a defined height, with the cylinder also extending into the interior space of the oil pan 16. The plate-shaped sealing element arrangement 2 is placeable with the inner geometry of the plate-shaped sealing element arrangement 2 onto the slightly smaller outer geometry of the cylindrical inner circular portion of the joining arrangement 3, so that the end face of the sealing element arrangement 2 facing the oil pan forms a common plane with the inner base of the oil pan 16.

FIG. 2 shows a more detailed view of the joining arrangement 3. The cylindrical inner circular portion includes the concentrically arranged through-hole 6 with an internal thread for mounting an oil pan cap 15 (FIG. 4) installed from the outside, as shown in FIG. 4. The internal thread is an annular element, wherein the annular element is arranged concentrically in the internal circular cylindrical portion and is connected via webs. The annular element has a lower height than the cylindrical portion and is arranged in the cylindrical portion. The annular element is arranged so as to be suspended with respect to the internal base of the oil pan. The inner circular cylindrical portion includes a second partial recess 10 across the entire height of the lateral surface, the second partial recess 10 extending up to the internal base of the oil pan 16. The second recess 10 forms a common connection to the through-hole 6 underneath the annular element. The outer circular portion of the joining arrangement 3 includes a ridge-like filling rotary stop 12 vertically arranged at the outer circumference, an undercut, L-shaped holding structure 17 for accommodating the sealing element arrangement 2, wherein the short lateral face of the L-shaped holding structure 17 is perpendicularly connected to the internal base of the oil pan 16, and a draining rotary stop 14, which is formed by the end face of the holding structure 17.

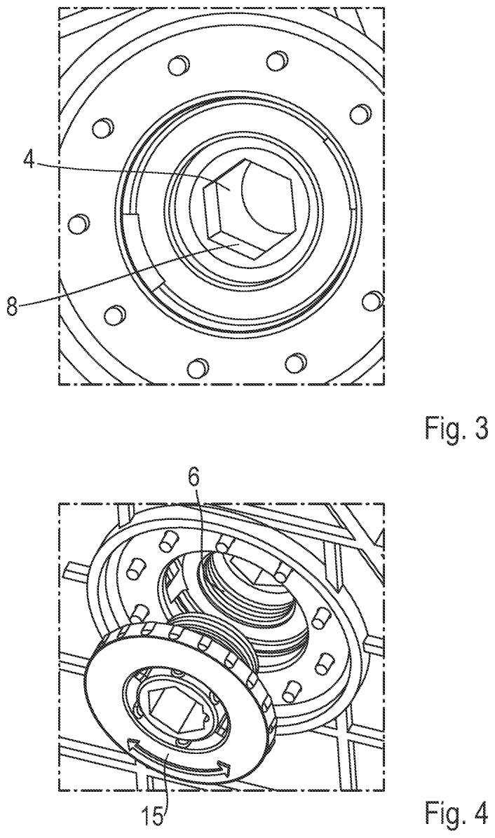

FIG. 3 shows the bottom view of the connection arrangement 1 shown in FIG. 1, particularly illustrating an actuating element 8 of the sealing element arrangement 2. The actuating element 8 is an internal hexagonal geometry at the inner surface of the filling passage 4 of the sealing element arrangement 2 and is formed across a partial vertical section.

FIG. 4 shows the bottom view of the oil pan arrangement 100 that includes the through-hole 6, wherein the through-hole 6 is to be closed with respect to the liquid L from the outside in the operating state via the oil pan cap 15 that includes an external thread and a sealing ring (not shown). The oil pan cap 15 includes an actuating element at the head side.

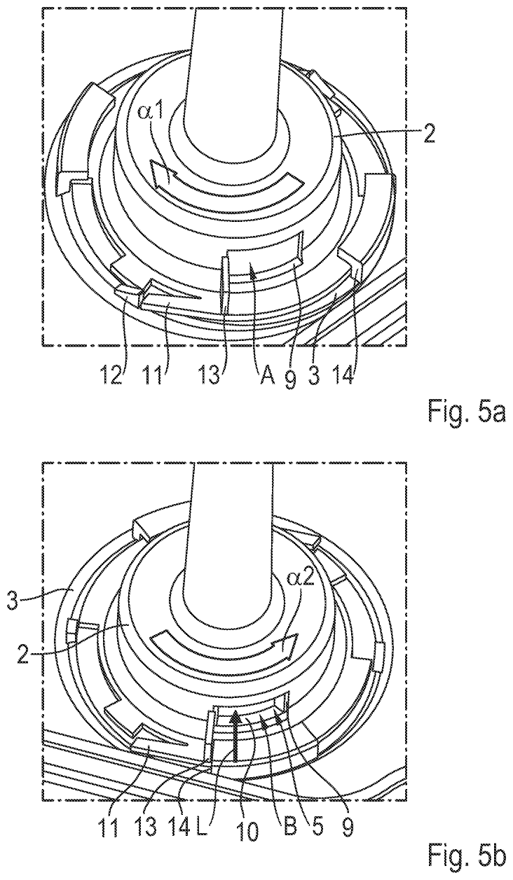

FIGS. 5a and 5b show a more detailed view of the sealing element arrangement 2 mounted on the joining arrangement 3. The plate-shaped sealing element arrangement 2 includes a plate edge area, wherein the plate edge area can also be referred to as a knuckle area. The plate edge area forms a common plane with the joining arrangement 3. A ridge-like sealing element rotary stop 13 is perpendicularly arranged on the plate edge area of the side facing away from the oil pan. In addition, the plate edge area includes a nose-shaped snap-action element 11, which is formed by recesses in the plate edge, wherein the tip of the nose of the snap-action element 11 is bent upward or downward in a vertical direction.

When mounting the sealing element arrangement 2 to the joining arrangement 3, the sealing element arrangement 2 is lowered from the mounting position C (FIG. 1) so the plate-edge area contacts the joining arrangement 3, and is then turned with respect to the joining arrangement 3 from the angular position of mounting position C (FIG. 1) in a direction α2 (FIG. 5b) so the snap-action element 11 elastically slides over the filling rotary stop 12 and the sealing element arrangement 2 is moved into the closed position A shown in FIG. 5a. It should be appreciated that, after passing completely over the rotary filling stop 12, the snap-action element 11 blocks a turning back into the angular position of the mounting position C (FIG. 1).

FIG. 5a shows the closed position A of the draining passage 5. FIG. 5b shows the open position B of the draining passage 5. In order to set the closed position A in FIG. 5a (e.g., from the closed position B in FIG. 5b), the sealing element arrangement 2 is turned with respect to the joining arrangement 3 in a direction α1 via the actuating element 8 (FIG. 3) until the tip of the nose of the snap-action element 11 impacts the filling rotary stop 12 and blocks the further turning displacement in the direction α1. At the same time, during the turning in the direction α1, the first recess 9 in the sealing element arrangement 2 moves in the direction 60 1, wherein the closed lateral region of the sealing element arrangement 2 completely closes the second recess 10 (FIG. 5b) in the joining arrangement 3. The draining passage 5 is closed. In order to set the open position B in FIG. 5b (e.g., from the closed position A in FIG. 5a), the sealing element arrangement 2 is turned with respect to the joining arrangement 3 in an opposite direction α2 via the actuating element 8 (FIG. 3) until the sealing element rotary stop 13 on the sealing element arrangement 2 impacts the draining rotary stop 14 and blocks the further rotary path in the direction α2. At the same time, during the turning in the direction α2, the first recess 9 on the sealing element arrangement 2 moves in the direction α2, wherein, at the maximally possible turning displacement in the direction α2, the first recess 9 is aligned with the second recess 10 and, in this way, opens the draining passage 5.

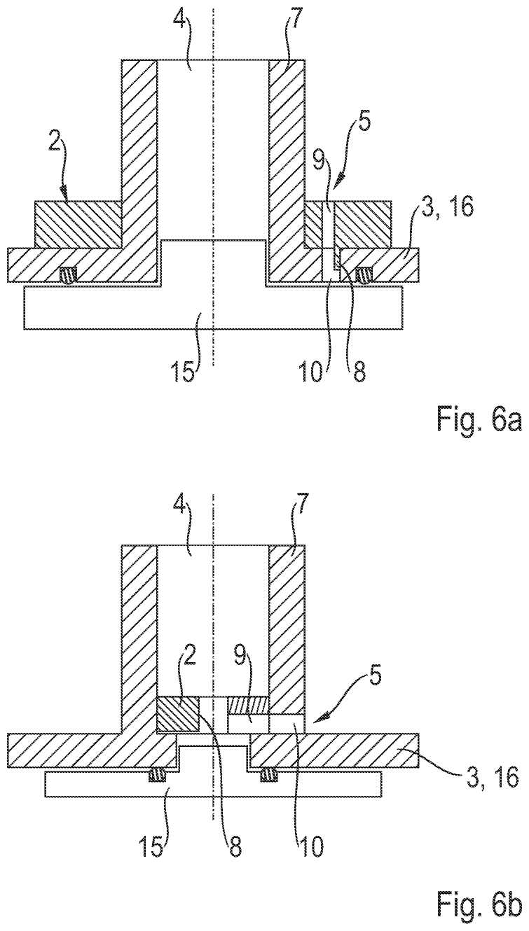

FIG. 6a shows a sectional view of a second embodiment of a connection arrangement 1, particularly having a draining passage 5. Unlike the connection arrangement 1 of FIG. 1, the joining arrangement 3 and the cylindrical filler tube 7 in FIG. 6a are one piece. The filler tube 7 connects the outer side of the oil pan 16 to the receiving chamber of the oil pan 16 and functions as a filling passage 4. The annular sealing element arrangement 2 is displaceably and concentrically arranged around the filler tube 7, wherein the end face of the sealing element arrangement 2 facing the oil pan forms a common plane with the inner side of the oil pan 16. The draining passage 5 is partially formed by a first recess 9 extending through the sealing element arrangement 2 and partially by a second recess 10 extending through the joining arrangement 3 when the first recess 9 and the second recess 10 are arranged in alignment with each other. The functional positions A,B are adjusted via a ridge-like actuating element 8, which is vertically attached at the edge area of the first recess 9 and extends partially through the second recess 10. The draining passage 5 and the filling passage 4 are closed in a liquid-tight manner via an oil pan cap 15 on the outside of the oil pan 16.

FIG. 6b shows a sectional view of a third embodiment of a connection arrangement 1, particularly having a draining passage 5. The joining arrangement 3 and the filler tube 7 in FIG. 6b are formed as one piece, unlike in FIG. 1. The filler tube 7 of FIG. 6b connects the outer side of the oil pan 16 with the receiving chamber of the oil pan 16 and functions as the filling passage 4. A displaceable, annular sealing element arrangement 2 is concentrically arranged inside of the filler tube 7, wherein an end face of the sealing element arrangement 2 facing the oil pan forms a common plane with the inner side of the oil pan 16. The sealing element arrangement 2 is held vertically in position via a shoulder in the filling passage 4. The draining passage 5 is partially formed by a first recess 9 extending horizontally through the sealing element arrangement 2 and partially by a second recess 10 extending horizontally through the filler tube 7 when the first recess 9 and the second recess 10 are arranged in alignment with each other. The functional positions NB are adjusted via an actuating element 8 as described in FIG. 3. The draining passage 5 and the filling passage 4 are closed in a liquid-tight manner via an oil pan cap 15 on the outside of the oil pan 16.

The described connection arrangement is not limited only to transmission oil pans, but rather can also be used at any other assembly (for example, engine oil pan) that is to be emptied and filled via an identical connection.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 connection arrangement
2 sealing element arrangement
3 joining arrangement
4 filling passage
5 draining passage
6 through-hole
7 filler tube
8 actuating element
9 first opening
10 second opening
11 snap-action element
12 filling rotary stop
13 sealing element rotary stop
14 draining rotary stop
15 oil pan cap
16 oil pan
17 holding structure
100 oil pan arrangement
A closed position
B open position
C mounting position
L liquid
α1 first direction of rotation
α2 second direction of rotation

1-10. (canceled)

11. A connection arrangement (1) for filling and draining a liquid, the connection arrangement (1) comprising:
a sealing element arrangement (2) movable between a closed position (A) and an open position (B); and
a joining arrangement (3),
wherein a filling passage (4) is defined by at least one of the sealing element arrangement (2) or the joining arrangement (3), and
wherein a draining passage (5) is definable by the sealing element arrangement (2) and the joining arrangement (3), the draining passage (5) being adjustable by moving the sealing element arrangement (2) between the closed position (A) and the open position (B).

12. The connection arrangement (1) of claim 11, wherein the joining arrangement (3) defines a through-hole (6) concentric to the filling passage (4), wherein the connection arrangement is fillable with liquid (L) through the through-hole (6) via the filling passage (4) when the sealing element arrangement (2) is in the closed position (A), and the liquid (L) is drainable through the through-hole (6) via the draining passage (5) when the sealing element arrangement (2) is in the closed position (B).

13. The connection arrangement (1) of claim 12, wherein the sealing element arrangement (2) includes a filler tube (7), a maximum fill level for the liquid (L) being limited by the filler tube (7).

14. The connection arrangement (1) of claim 12, wherein the sealing element arrangement (2) defines a first opening (9) and includes an actuating element (8) in the filling passage (4), wherein the actuating element (8) is accessible through the through-hole (6) to move the sealing element arrangement (2) between the closed position (A) and the open position (B).

15. The connection arrangement (1) of claim 14, wherein the joining arrangement (3) defines a second opening (10), the second opening (10) aligning with the first opening (9) when the sealing element arrangement (2) is in the open position (B) such that the first opening (9), the second opening (10), and the through-hole (6) together form the draining passage (5), the second opening (10) being closed by the sealing element arrangement (2) when the sealing element arrangement (2) is in the closed position (A).

16. The connection arrangement (1) of claim 11, wherein the sealing element arrangement (2) is mountable onto the joining arrangement (3) when in an angular position of a mounting position (C), the sealing element arrangement (2) being nondetachably lockable to the joining arrangement (3) when turned relative to the joining arrangement (3) from the angular position to a functional position range (A/B),
wherein the joining arrangement (3) defines a holding structure (17), the sealing element arrangement (2) being fixed against being lifted off the joining arrangement via the holding structure (17) when in the functional position range (A/B).

17. The connection arrangement (1) of claim 16, wherein the functional position range (A/B) is defined between the closed position (A) and the open position (B) such that the sealing element arrangement (2) is displaceable between the closed position (A) and the open position (B) when in the functional position range (A/B).

18. The connection arrangement (1) of claim 17, wherein the functional position range (A/B) is settable by limiting a maximum turning displacement of the sealing element arrangement (2) between the closed position (A) and the open position (B), the closed position (A) being set where an elastic snap-action element (11) at the sealing element arrangement (2) and a filling rotary stop (12) on the joining arrangement (3) contact when turning the sealing element arrangement (2) in a first direction of rotation (α1), the open position (B) being set where a ridge-shaped filler tube rotary stop (13) arranged on the sealing element arrangement (2) and a draining rotary stop (14) arranged on the joining arrangement (3) contact when turning the sealing element arrangement (2) in a second direction of rotation (α2).

19. The connection arrangement (1) of claim 11, further comprising:
an oil pan (16) of a transmission, the joining arrangement (3) and the oil pan (16) being formed together as one piece, the oil pan (16) being fillable and drainable with the liquid (L) via a through-hole (6) defined by the joining arrangement (3) and concentric to the filling passage (4); and
an oil pan cap (15), the through-hole (6) being closeable in a liquid-tight manner via the oil pan cap (15),
wherein the liquid (L) is a lubricating fluid or cooling liquid.

20. The connection arrangement (1) of claim 19, wherein the sealing element arrangement (2) is horizontally displaceable between the closed position (A) and the open position (B) using an actuating element (8) in the filling passage (4) accessed from outside of the oil pan (16) through the through-hole (6).

21. An oil pan arrangement (100), comprising an oil pan (16), the oil pan (16) being fillable and drainable via the connection arrangement (1) of claim 11 positioned in a bottom area of the oil pan (16).
